(19) United States
(12) Patent Application Publication
(10) Pub. No.: US 2019/0124111 A1
(43) Pub. Date: Apr. 25, 2019

(54) RESPONDING AND PROCESSING METHOD FOR DNSSEC NEGATIVE RESPONSE

(71) Applicant: CHINA INTERNET NETWORK INFORMATION CENTER, Beijing (CN)

(72) Inventors: Xiaodong LI, Beijing (CN); Hongtao LI, Beijing (CN); Jueyu YE, Beijing (CN); Haikuo ZHANG, Beijing (CN); Nan WANG, Beijing (CN); Xiali YAN, Beijing (CN); Xue YANG, Beijing (CN)

(73) Assignee: CHINA INTERNET NETWORK INFORMATION CENTER, Beijing (CN)

(21) Appl. No.: 16/089,366

(22) PCT Filed: Feb. 22, 2017
(86) PCT No.: PCT/CN2017/074405

§ 371 Date: Sep. 27, 2018

(30) Foreign Application Priority Data
Sep. 9, 2016 (CN) 201610814681.4

(51) Int. Cl. H04L 29/06; H04L 29/12; H04L 9/06

(52) U.S. Cl. CPC H04L 63/1458; H04L 63/1416; H04L 9/0643; H04L 61/1511; H04L 61/1552

(57) ABSTRACT

Provided by the present invention is a responding and processing method for a domain name system security extensions (DNSSEC) negative response. The responding method comprises the following steps: step A1, an authoritative domain name system (DNS) server loading DNS data by means of zone files; step A3, the authoritative DNS server conducting SHA1 encryption and base32 coding calculation on all loaded domain names and saving calculation results; and step A5, the authoritative DNS server receiving a DNS query. By means of the present invention, the responding speed of a DNSSEC negative response does not obviously decrease compared to ordinary queries. According to a characteristic, wherein the length of the DNSSEC negative response message increases a lot compared to a normal response message, the present invention may detect a distributed denial-of-service (DDOS) attack against a DNSSEC negative response query.

### FIELD

The present disclosure relates to the field of DNS security, and in particular to a responding method for a DNSSEC negative response and a processing method for a DNSSEC negative response.

### BACKGROUND

The Domain Name System Security Extensions DNSSEC is a security extension of a DNS. The DNSSEC indicates a series of DNS security authentication mechanisms provided by the IETF (referring to RFC2535), which provides a method for verifying the authenticity and integrity of responses. In this method, a domain name resolver may verify whether the received response (including a response for name non-existence) is transmitted from a real server, or whether the response is tampered in the transmission, by using the cryptogram technology. At present, root domains, multiple top-level domains and national top-level domains are deployed with DNSSEC. With the DNSSEC, the identity authentication on the DNS domain name server is more strictly, thereby preventing attacks such as DNS cache pollution. The DNSSEC plays an important role in protecting the resolver from being deceived, and becomes an important part for achieving the DNS security.

In order to verify the response for name non-existence, the NSEC3 resource record (referring to RFC5155) is introduced in the DNSSEC. The owner name of the NSEC3 resource record is the base32 encoding having 32 bytes in length, of the hashed owner name with hash algorithm SHA1 prepended as a single label to the name of the zone. The query returned no more than three NSEC3 resource records and the corresponding Resource Record Signature (RRSIG) that prove that the requested data does not exist. In order to reply to the NSEC3 resource records, the authoritative DNS server generally performs the SHA1 encryption and base32 encoding for multiple times, which greatly reduces the response rate of the authoritative DNS server for the DNSSEC negative response. At present, the above problem usually occurs during the use of some common DNS software applications. In this case, the DNSSEC makes DNS more vulnerable to a new class of denial of service attacks based on cryptographic operations, as an attacker can attempt to use DNSSEC mechanisms to consume a victim's resources.

### SUMMARY

An object of the present disclosure is to improve a response rate of an authoritative DNS server for a DNSSEC negative response, and reduce the risk of a distributed denial of service (DDOS) attack against the DNSSEC negative response.

A responding method for a DNSSEC negative response is provided in the present disclosure, which includes:
step A1: loading, by an authoritative DNS server, DNS data from a zone file;
step A3: performing, by the authoritative DNS server, SHA1 encryption and base32 encoding operation on each of all loaded domain names, and storing, by the authoritative DNS server, operation results; and
step A5: receiving, by the authoritative DNS server, a DNS query.

Specifically, step A5 includes:
step A51: determining whether the DNS query requests a DNSSEC response; and
step A53: processing, by the authoritative DNS server, the DNS query if the DNS query requests a DNSSEC response.

Specifically, step A53 includes:
step A531: determining, by the authoritative DNS server, whether to return a DNSSEC negative response for the DNS query;
step A533: searching a NSEC3 record based on the operation results obtained in step A3, to form a DNSSEC negative response message, if the authoritative DNS server determines to return a DNSSEC negative response for the DNS query; and
step A535: returning, by the authoritative DNS server, a DNS response packet containing the DNSSEC negative response message.

A processing method based on the responding method for a DNSSEC negative response is further provided in the present disclosure, which includes:
step B1: setting a DDOS detection threshold;
step B3: calculating the number of received queries with a DNSSEC negative response; and
step B5: determining, based on a comparison between the number of the queries and the threshold, whether there is a DDOS attack against the DNSSEC negative response.

In step B1, the DDOS detection threshold is indicated by a ratio of a bandwidth to an average length of a DNS response packet containing the DNSSEC negative response which is the DNS response packet returned by the DNS server in step A535.

In step B5, if the number of the received queries with a DNSSEC negative response is greater than the detection threshold, it is indicated that there is a DDOS attack against the DNSSEC negative response.

The present disclosure has the following advantages. Since no additional operation is performed in query processing, the response rate for the DNSSEC negative response is not significantly decreased compared with that for a normal query. In addition, since the size of the DNSSEC negative response packet is significantly increased compared with that of a normal response packet, a DDOS attack detection method for a query with a DNSSEC negative response is provided.

### BRIEF DESCRIPTION OF THE DRAWINGS

Various other advantages and benefits are apparent to those skilled in the art when reading the description of the preferred embodiments hereinafter. The drawings are only for the purpose of illustrating the preferred embodiments and are not construed as limitative. Throughout the drawings, the same components are denoted by the same reference numerals. In the drawings:

FIG. 1 is a flowchart showing a processing method for a DNSSEC negative response in the conventional technology;

FIG. 2 shows a comparison between response rates for a normal query and a DNSSEC negative response; and

FIG. 3 is a flowchart showing a processing method for a DNSSEC negative response according to an embodiment of the present disclosure.

### DETAILED DESCRIPTION

Exemplary embodiments of the present disclosure are described in more detail below with reference to the drawings. While the exemplary embodiments of the present disclosure are shown in the drawings, it should be understood that the present disclosure may be implemented in various forms and are not limited to the embodiments set forth herein. The embodiments are provided such that the present disclosure can be more fully understood and the scope of the present disclosure can be fully conveyed to those skilled in the art.

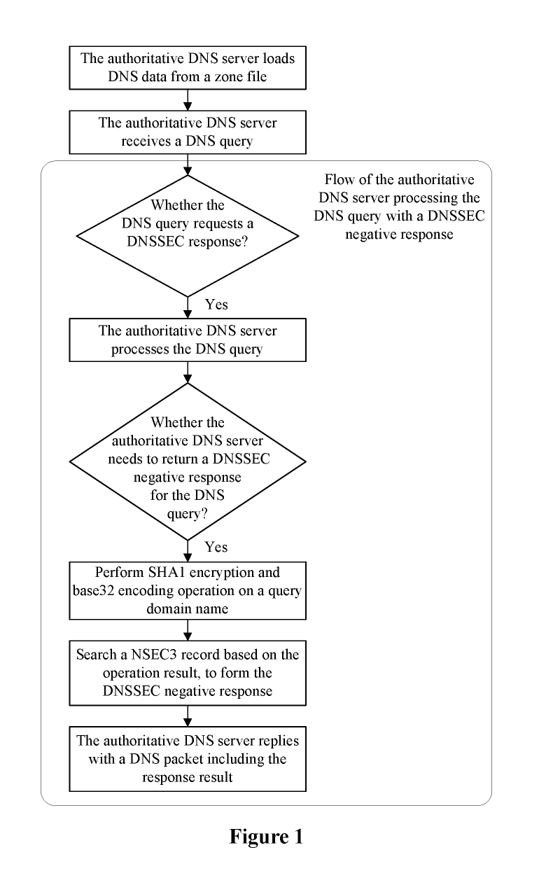

FIG. 1 is a flowchart showing a processing method for a DNSSEC negative response in the conventional technology, which includes the following steps 1 and 2.

In step 1, an authoritative DNS server loads DNS data from a zone file.

In step 2, the authoritative DNS server receives a DNS query.

If the authoritative DNS server continues to process the DNS query with a DNNSEC negative response, the authoritative DNS server determines whether the DNS query requests a DNSSEC response. Then the authoritative DNS server processes the DNS query if the DNS query requests a DNSSEC response. And then the authoritative DNS server determines whether to return a DNSSEC negative response. If the authoritative DNS server determines to return a DNSSEC negative response for the DNS query, the authoritative DNS server performs SHA1 encryption and Base32 encoding operation on a query domain name, and searches a NSEC3 record based on the operation result to form the DNSSEC negative response. Finally, the authoritative DNS server replies with a DNS packet including the response result.

Based on the conventional technical solution, in order to search the corresponding NSEC3 resource record, it is required to perform multiple times, the secure hash algorithm SHA1 encryption and the Base32 encoding operation for each DNSSEC negative response. For a single DNS query, the entire operation is tedious, which increases the processing time of the single query, and reduces the number of queries that the DNS server can process per second.

In the Base32 data encoding, binary data is encoded into visible character strings. The principle of the Base32 data encoding is that: any binary data is divided into several groups with each group including five bits (for the base64 data encoding, each group includes 6 bits), and bits in each group are encoded to obtain a visible character. The total number of characters in the Base32 encoding table character set is 2⁵=32, which is the origin of the name of Base32.

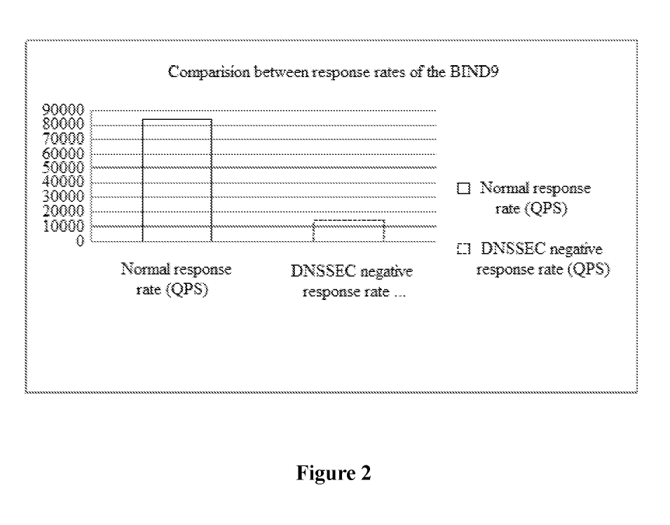

FIG. 2 shows a comparison between response rates of the most commonly used DNS software BINDS for a DNSSEC negative response and a normal query response. It can be seen from FIG. 2 that, the response rate for the DNSSEC negative response is significantly decreased compared with that for the normal query response.

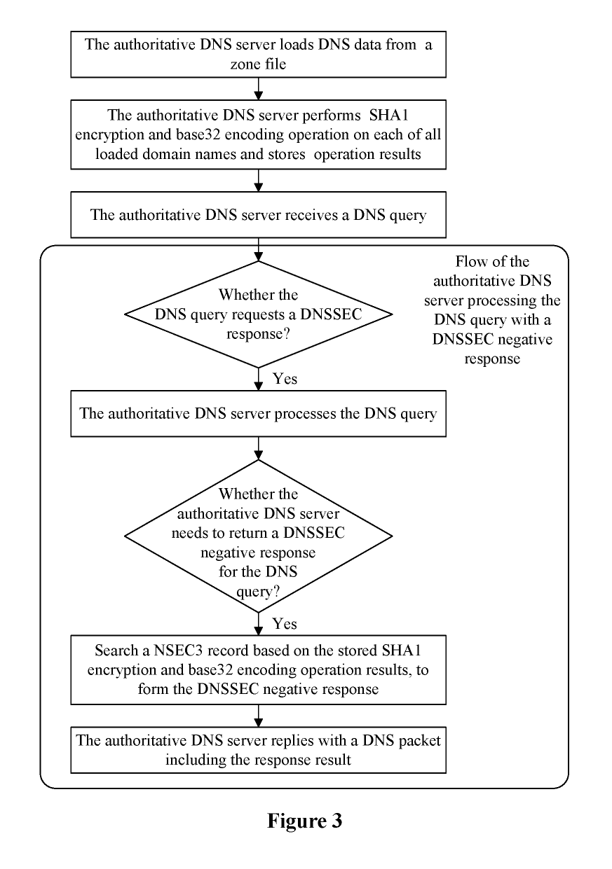

In order to overcome the above disadvantage, a method is provided in the present disclosure. As shown in FIG. 3, a quick responding method for a DNSSEC negative response is provided, which includes the following steps A1, A3 and A5.

In step A1, an authoritative DNS server loads DNS data from a zone file.

In step A3, the authoritative DNS server performs SHA1 encryption and base32 encoding operation on each of all loaded domain names and stores operation results.

In step A5, the authoritative DNS server receives a DNS query.

Specifically, step A5 may include the following steps A51 and A53.

In step A51, it is determined whether the DNS query requests a DNSSEC response.

In step A53, the authoritative DNS server processes the DNS query if the DNS query requests a DNSSEC response.

Specifically, step A53 may include: the following steps A531, A533 and A535.

In step A531, the authoritative DNS server determines whether to return a DNSSEC negative response for the DNS query.

In step A533, if the authoritative DNS server determines to return a DNSSEC negative response for the DNS query, a NSEC3 record is searched based on the operation results obtained in step A3, to form a DNSSEC negative response message.

In step A535, the authoritative DNS server returns a DNS response packet containing the DNSSEC negative response message.

The technical solution according to the present disclosure differs from the conventional technical solution mainly in the time instant of performing the SHA1 encryption and base32 coding operation. In the technical solution according to the present disclosure, the SHA1 encryption and base32 coding operation is performed after the DNS data is loaded, rather than being performed in query processing. In this way, the NSEC3 resource record is searched based on the operation results in the query processing, which is similar to the case for a normal DNS query, such that processing time for a single query is not increased. In addition, the data structure and the algorithms are optimized, such that the time for loading the DNS data is not increased due to the SHA1 encryption and base32 encoding operation.

The NESC3 resource record (RR) is used to verify whether a DNS resource record does not exist. The NSEC3 RR has the same function as the NSEC RR, except that encrypted hash record names are used in the NSEC3 so as to not list record names in the zone. The NSEC3 record is linked to a next record name in the zone (which is ranked in a hash name order), and a record type that exists for a name covered by the hash value in a first tag of a name of an owner of the NSEC3 record is listed. The record can be processed by the parser to verify the non-existence of the record name and the record type, as a part of the DNSSEC verification. The NSEC3 record may include the following data elements.

A hash algorithm may be included, i.e., a used cryptographic hash algorithm.

A flag “Opt-out” may be included, which indicates whether a delegate is signed.

Information on iteration may be included, which indicates the number of times for which the hash algorithm is applied.

A parameter “salt” may be included, which indicates a salt value used for hash operations.

Information on a name of a next hash owner may be included, which indicates a name of a next record in the zone (which is ranked in a hash name order).

Information on a record type may be included, which indicates a record type that exists for the name covered by the hash value in the first tag of the name of the owner of the NSEC3 record.

Since the DNSSEC negative response contains multiple NSEC3 resource records and signature resource records thereof, a size of the response packet is larger than a size of a normal response packet (up to 13 times of the size of the normal packet). In this case, the DNSSEC negative response is frequently replied, which may apply a heavy load on the network bandwidth. Due to this feature, a hacker may attack the DNS. Therefore, a DDOS detection method for a DNSSEC negative response is further provided in the present disclosure. In the method, a threshold is set for the number of queries with a DNSSEC negative response by calculation. The threshold is indicated by a ratio of a bandwidth to an average length of a DNSSEC negative response packet. If the number of the received queries with a DNSSEC negative response exceeds the threshold, it is indicated that there may be a DDOS attack against the DNSSEC negative response. When such a DDOS attack is found, the DDOS attack protection is performed by a front-end DNS protection device or by using other security protection methods.

A processing method for a DNSSEC negative response is further provided in the present disclosure, which includes the following steps B1, B3 and B5.

In step B1, a DDOS detection threshold is set.

In step B3, the number of received queries with a DNSSEC negative response is calculated.

In step B5, based on a comparison between the number of the queries and the threshold, it is determined whether there is a DDOS attack against the DNSSEC negative response.

In step B1, the DDOS detection threshold is indicated by a ratio of a bandwidth to an average length of the DNS response packet containing the DNSSEC negative response message. The DNS response packet containing the DNSSEC negative response message herein is the DNS response packet returned by the DNS server in step A535.

In step B5, if the number of the received queries with a DNSSEC negative response is greater than the detection threshold, it is indicated that there is a DDOS attack against the DNSSEC negative response.

The above shows only preferred embodiments of the present disclosure, but the scope of the present disclosure is not limited thereto. Changes or alternatives easily made by those skilled in the art within the technical scope of the present disclosure shall fall within the scope of the present disclosure. Therefore, the protection scope of the present disclosure is defined by the claims.

1. A responding method for a domain name system security extensions (DNSSEC) negative response, comprising:
step A1: loading, by an authoritative DNS server, DNS data from a zone file;
step A3: performing, by the authoritative DNS server, SHA1 encryption and base32 encoding operation on each of all loaded domain names, and storing, by the authoritative DNS server, operation results; and
step A5: receiving, by the authoritative DNS server, a DNS query.

2. The responding method for a DNSSEC negative response according to claim 1, wherein step A5 comprises:
step A51: determining whether the DNS query requests a DNSSEC response; and
step A53: processing, by the authoritative DNS server, the DNS query if the DNS query requests a DNSSEC response.

3. The responding method for a DNSSEC negative response according to claim 2, wherein step A53 comprises:
step A531: determining, by the authoritative DNS server, whether to return a DNSSEC negative response for the DNS query;
step A533: searching a NSEC3 record based on the operation results obtained in step A3, to form a DNSSEC negative response message, if the authoritative DNS server determines to return a DNSSEC negative response for the DNS query; and
step A535: returning, by the authoritative DNS server, a DNS response packet containing the DNSSEC negative response message.

4. A processing method based on the responding method for a DNSSEC negative response according to claim 3, comprising:
step B1: setting a distributed denial of service (DDOS) detection threshold;
step B3: calculating the number of received queries with a DNSSEC negative response; and
step B5: determining, based on a comparison between the number of the queries and the threshold, whether there is a DDOS attack against the DNSSEC negative response.

5. The processing method according to claim 4, wherein in step B1,
the DDOS detection threshold is indicated by a ratio of a bandwidth to an average length of a DNS response packet containing the DNSSEC negative response message which is the DNS response packet returned by the DNS server in step A535.

6. The processing method according to claim 4, wherein in step B5, if the number of the received queries with a DNSSEC negative response is greater than the detection threshold, it is indicated that there is a DDOS attack against the DNSSEC negative response.
